(19) United States
(12) Patent Application Publication
(10) Pub. No.: US 2011/0100154 A1
(43) Pub. Date: May 5, 2011

(54) Ergonomic bicycle hand rest

(76) Inventor: Paul D. Johnson, Knightdale, NC (US)

(21) Appl. No.: 12/925,729

(22) Filed: Oct. 28, 2010

Related U.S. Application Data
(60) Provisional application No. 61/280,478, filed on Nov. 5, 2009.

(51) Int. Cl. B62K 21/26

(52) U.S. Cl. 74/551.9

(57) ABSTRACT

A bicycle hand placement surface element for bicycles with hand brakes mounted on drop style handlebars that creates a new ergonomic hand position while riding the bicycle that reduces stress in the hand, palm, web and wrist while absorbing significant road shock and vibration. This element may be self forming to each riders hand and is significantly larger than the top of a hand brake to better distribute the rider's weight uniformly across the riders palm to reduce high pressure points. This element can be added to an existing hand brake, made as an integral part of the hand brake or mounted separately to the handlebars.

### CROSS-REFERENCE TO RELATED PATENTS

61/280,478 (Provisional)

### STATEMENT REGARDING FEDERALLY SPONSORED RESEARCH OR DEVELOPMENT

Not Applicable

### REFERENCE TO SEQUENCE LISTING, TABLE, COMPUTER PROGRAM, COMPACT DISC

Not Applicable

### BACKGROUND OF THE INVENTION

This invention relates to bicycle hand brakes, riding position, hand placement, ergonomic bicycle riding positions, minimization of muscle stress, tendon stress and pressure points on the hand. The invention is not limited to these classifications and particulars.

There are typically two hand brakes on a bicycle and all descriptions are made equally to both left and right hand brakes. The term hand brake refers of the entire brake assembly that is attached to the handlebars and includes the lever, main body, fastening method and protective covering.

This invention pertains particularly to bicycles with hand brakes mounted on drop style handlebars and deals primarily with one of the hand positions of a bicycle rider while riding such a bicycle as they straddle their hands across the top of the hand brakes (see FIG. 2). This position requires the rider to twist their hands approximately 90 degrees from the body's natural position to meet up with the top surface of the hand brake. This introduces stress on the wrist, elbow and shoulder joints. This stress in time becomes uncomfortable. The rider's wrist is also forced to maintain an angle between the hand and forearm while supporting the rider's upper body weight. This causes additional muscle stress and soreness in the wrist after time.

The natural position is defined as how one naturally positions their hands, wrists, arms, elbows and shoulders as they reach out in front of them with their fingers pointing forward. In this position the back of the hands are facing upward and the palms are facing the ground.

Typically on hand brakes there is a sharp rise or protrusion where the palm of the hand is placed. This places a large amount of stress in the riders palm causing discomfort.

At times the web between the finger and thumb is pushed up against the protrusion in the hand brake. This creates stress and soreness in the tendons and skin of the web.

Hand brake designs are typically narrow relative to the riders palm and are not contoured to the palm. Applying the riders hand against such a small surface area, no matter the hand placement, causes high pressure points on the palm which causes discomfort during a ride.

Depending on the hand brake design there could be brake cables protruding out the top or side that interferes with the riders hand placement and fingers. This limits the ability to move the hand around to find a more comfortable hand position.

The handbrake is typically covered in an approximately ⅛″ thick elastomer covering to protect the hand brake from moisture and debris. This covering is not thick enough or soft enough to conform to the shape of the hand. Therefore the hand is forced to conform to the shape of the hand brake which after some time becomes uncomfortable.

This approximately ⅛″ thick covering is not thick enough to take up any meaningful road shock or vibration. Consequently this road shock and vibration is transferred almost directly to the riders hand and up the arms to their body. This constant jarring wears on the whole body of the rider.

### BRIEF SUMMARY OF THE INVENTION

The objective of this invention is to increase bicycle riding comfort by relieving various muscle stresses in the arms of the rider and to decrease high pressure points in the hand. The invention is a hand placement surface that can be created by various elements that provide a placement area for the hands that put the hand, wrist, elbow and shoulders in a more ergonomic or natural position while riding (see FIG. 4). Being in the natural position relieves the discomfort experienced by holding the hands in an unnatural position for long periods of time. This hand placement surface also moves the hand above any protrusions in the hand brake, increases the surface area for the palm and can conform to each individual's palm shape all of which reduce discomfort associated with high pressure points in the hand. With the hand in the natural position the rider no longer bears weight down on the web between the index finger and thumb relieving stress in this area all together. Another benefit of the natural riding position is that the wrist no longer holds the hand and forearm in alignment eliminating wrist fatigue altogether. Various embodiments of the invention provide a significant amount of shock and vibration absorption which also alleviates discomfort to the entire upper body of the rider. This invention can be embodied so as to mount on existing hand brakes, be incorporated into a hand brake design or attached to the handlebars as a separate element.

### BRIEF DESCRIPTION OF THE SEVERAL VIEWS OF THE DRAWING

FIG. 1 illustrates a drop style handlebar with attached hand brake.

FIG. 2 illustrates the hand position of a rider while straddling their hands across the top of the hand brake.

FIG. 3 illustrates a shaped padded element positioned on top of the hand brake. A minimal form of the element is shown for simplicity.

FIG. 4 illustrates the natural ergonomic position when riding with a shaped padded element under the palm.

FIG. 5 illustrates a movable solid element on top of the hand brake attached at a pivot point. The two extreme positions of the element are shown. One of the two positions is shown as dashed lines.

FIG. 6 illustrates a solid element on top of the hand brake attached by a strap.

FIG. 7 illustrates a shaped padded element on top of the hand brake, taped to the hand brake. The method shown is similar to the taping of drop handlebars.

FIG. 8 illustrates a shaped padded element on top of the hand brake attached with a flexible covering.

FIG. 9 illustrates a shaped padded element integrated into the molded brake protective covering. This figure also shows an enlarged padded area for the palm.

### DETAILED DESCRIPTION OF THE INVENTION

Before one or more embodiments of the invention is explained in detail, it is to be understood that the invention is not limited in its application to the details of construction described herein or as illustrated in the drawings. The invention is capable of other embodiments and of being practiced or carried out in various other ways. Further, it is to be understood that the phraseology and terminology used herein is for the purpose of description and should not be regarded as limiting.

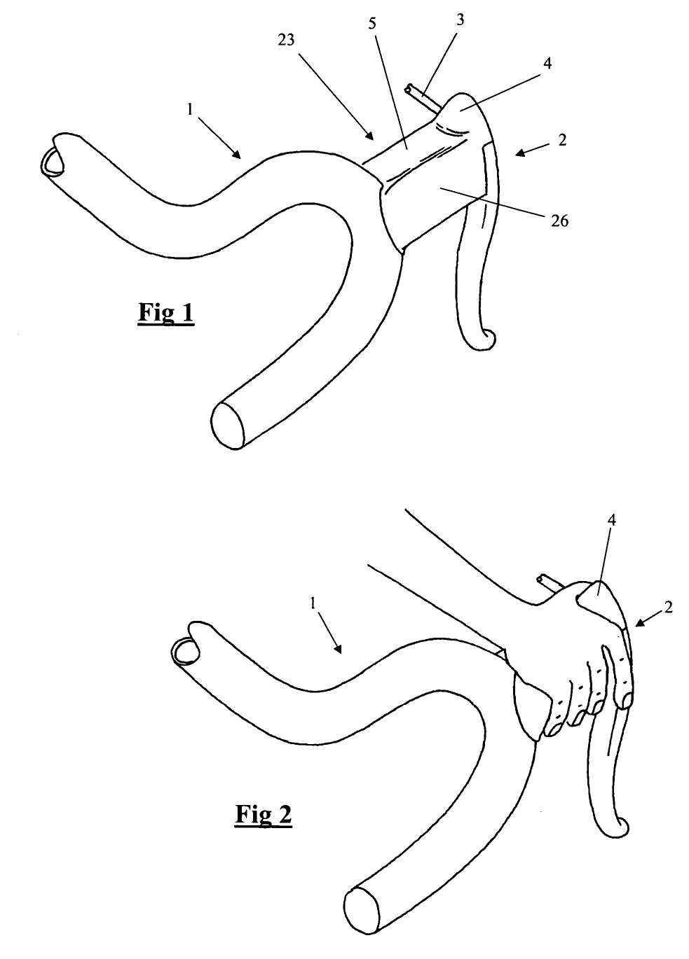

See FIG. 1,3,4,6,7,8,9 A hand placement surface 24 may be created by a shaped element 8 added to the top 5 of the hand brake 2 that conforms to the rider's palm 9. The element 8 sets in and fills the saddle area 23 of the hand brake 2. The element's top surface 24 is level or slightly above any protrusions 4 of the hand brake 2. This element 8 is specifically shaped to create a large surface area 27 for the palm 9 up to approximately twice the area of the hand brake top surface 5. This element 8 can be various shapes, sizes, materials or hardness and still meet the scope of the patent. The final shape and placement of the element 8 should be such that the rider naturally places their palm 9 atop the elements surface 24, the hand automatically takes the natural position 22, the hand is clear of all cables 3 and hand brake protrusion 4, the wrist muscles 25 are not used to hold the hand in position, the heel of the palm 28 supports the riders weight and most importantly the hand 22 is at rest. The element 8 could be any form of elastomer that is molded, extruded, cut or otherwise formed into the shape described. The element 8 may be attached to the existing hand brake 2 or handlebar 1 by either strap 14, tape 15, or flexible covering 17. The tape 15 can be adhesive or non-adhesive.

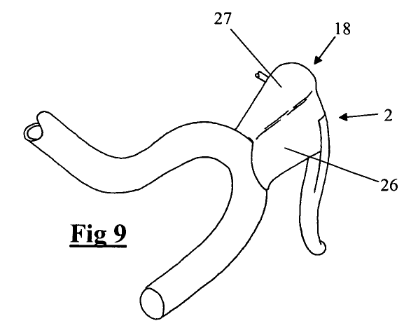

See FIG. 9 An alternate hand placement surface 27 may be created as an integral part of the hand brake 2 by being either molded as part of the protective covering 18 or placed between the protective covering 18 and brake housing 26 or formed as part of the hand brake housing 26 itself.

See FIG. 4,5,6,7,8 Another alternate hand placement surface 13 may be a semi-rigid element 11 affixed to the hand brake housing 26. This element 11 is specifically shaped to create and maintain a large surface area 13 contoured to the rider's palm 9. This element would be firm enough to maintain it's basic shape under the weight of the riders hand 22. The element 11 could either be solidly fixed or be made to pivot about a point 16 so as to follow the angle of the riders palm 9 as the rider moves from position 19 to position 20 or it could be fastened to the brake housing 26 with an elastomer intermediary so it could allow similar tracking of the rider's movements without a solid fixing point 16. Any of the other fixing methods to the existing hand brake 2 or handlebar 1 by either strap 14, tape 15, or flexible covering 17 may apply as well.

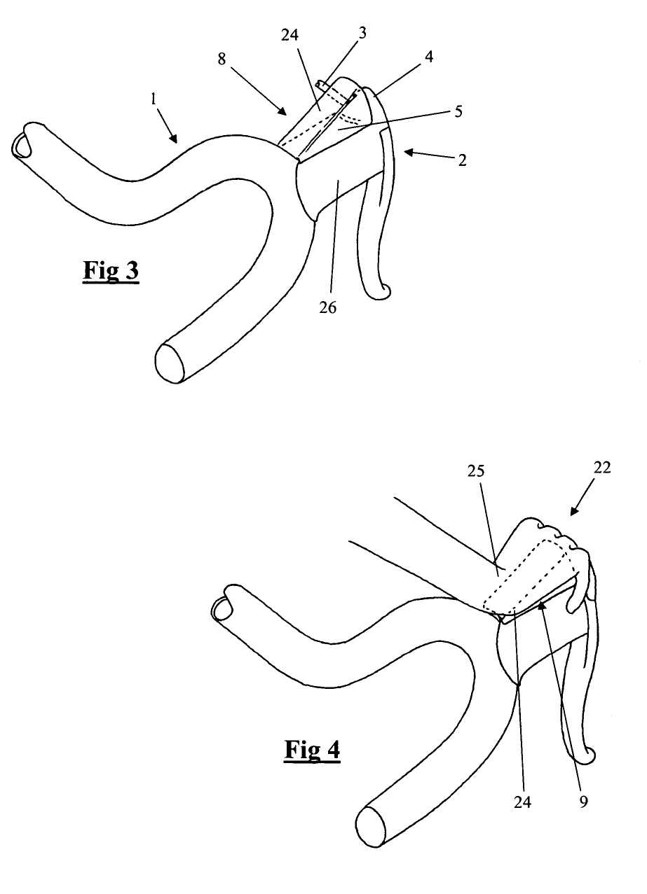

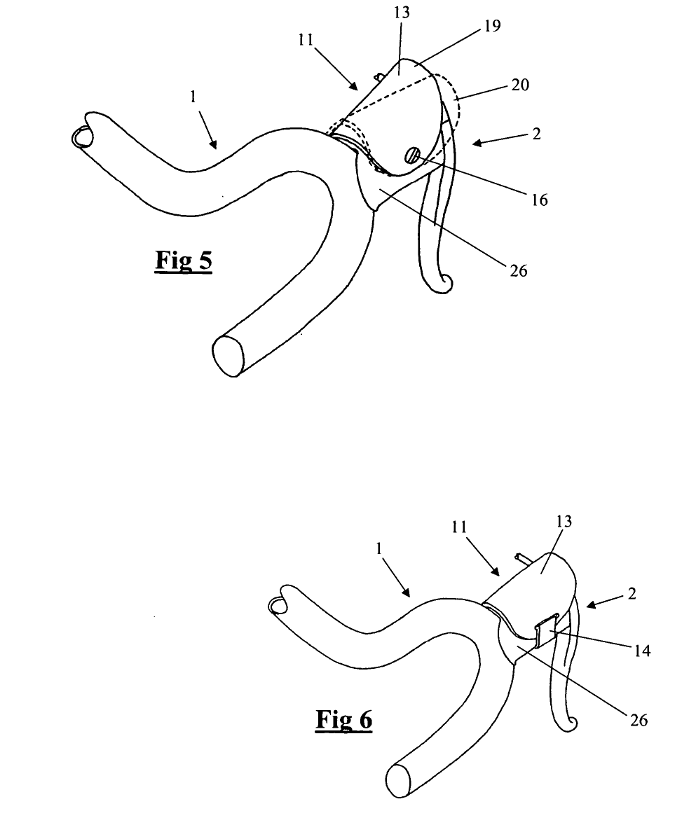

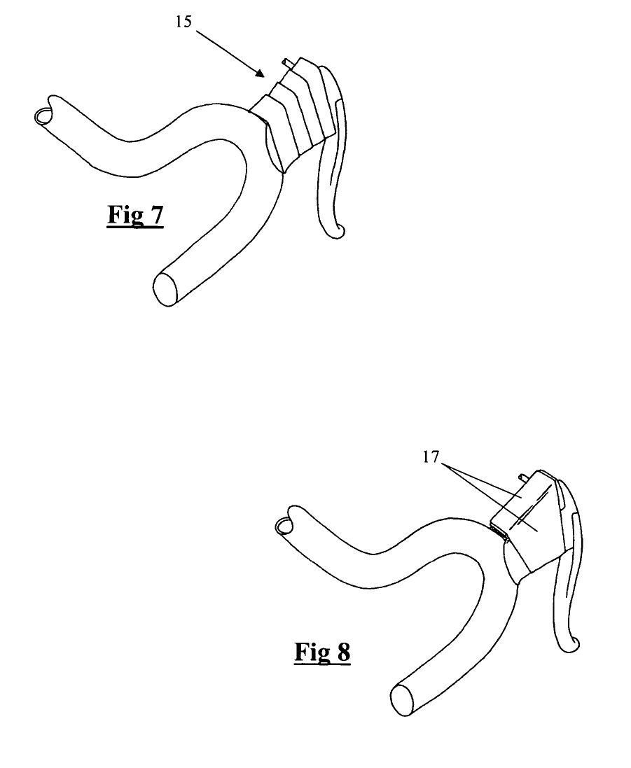

FIG. 3,5,9 Any of the previously mentioned hand placement surfaces 13,24,27 may be created by a separate element attached directly to the handlebars 1. The same fixing means for the hand brakes could be used to support the hand placement surfaces 13,24,27 apart from the hand brakes. This would serve the same stated purposes of the hand placement surfaces 13,24,27 and could be embodied in the same manner.

Any combination of these elements and mountings could occur depending on the desired design, cost and aesthetics. These descriptions are offered by way of clarifying the invention but are not intended to limit the scope of the invention claims nor does it limit the implementation of the invention to these listed embodiments.

1. A hand placement surface in the close proximity of the hand brakes of drop style road bicycle handlebars comprising of
a surface for the palm of the hand that provides a hand placement position that puts the riders hand in the natural position while riding;
a mounting means to attach the hand placement surface to the bicycle handlebars or hand brakes.

2. The hand placement surface of claim 1 that allows the hand, arm and shoulder to be in the natural position as the rider places their hands upon the hand placement surface.

3. The hand placement surface of claim 1 that reduces the stress in the rider's wrist muscles by creating a surface for the heel of the palm to rest upon such that the riders weight is transferred to the bicycle through the heel of the palm and the wrist muscles are not required to keep the arm and hand in alignment.

4. The hand placement surface of claim 1 that provides a stress free riding position for the web between the thumb and forefinger by creating a surface for the heel of the palm to rest upon such that the riders' weight is transferred to the bicycle through the heel of the palm and the web does not carry the riders' weight.

5. The hand placement surface of claim 1 that decreases high pressure areas in the palm by creating a significantly larger surface area for the palm than the hand brake alone.

6. The hand placement surface of claim 1 that eliminates pressure points in the palm by providing a surface flush with or above any protrusions in the hand brake.

7. The hand placement surface of claim 1 that provides a surface to keep the hand out of the way of the cables protruding from the hand brake.

8. The hand placement surface of claim 1 with a sub-surface volume of elastomeric material of approximately 1″ thick at it's thickest point.

9. The hand placement surface of claim 8 that conforms to each individual rider's palm regardless of the individual's hand shape, size or position on the hand placement surface due to the elastomeric properties and thickness.

10. The hand placement surface of claim 8 that absorbs road shock and vibration due to the elastomeric properties and thickness.

11. An elastomeric hand placement surface in the close proximity of the hand brakes of drop style road bicycle handlebars comprising of:
a surface for the palm of the hand that provides a hand placement position that puts the riders hand in the natural position while riding;
a sub-surface volume of elastomeric material of approximately 1″ thick;
a mounting means to attach the surface and elastomeric material to the bicycle.

12. The hand placement surface of claim 11 that allows the hand, arm and shoulder to be in the natural position as the rider places their hands upon the hand placement surface.

13. The hand placement surface of claim 11 that reduces the stress in the rider's wrist muscles by creating a surface for the heel of the palm to rest upon such that the riders weight is transferred to the bicycle through the heel of the palm and the wrist muscles are not required to keep the arm and hand in alignment.

14. The hand placement surface of claim 11 that provides a stress free riding position for the web between the thumb and forefinger by creating a surface for the heel of the palm to rest upon such that the riders' weight is transferred to the bicycle through the heel of the palm and the web does not carry the riders' weight.

15. The hand placement surface of claim 11 that decreases high pressure areas in the palm by creating a significantly larger surface area for the palm than the hand brake alone.

16. The hand placement surface of claim 11 that eliminates pressure points in the palm by providing a surface flush with or above any protrusions in the hand brake.

17. The hand placement surface of claim 11 that provides a surface to keep the hand out of the way of the cables protruding from the hand brake.

18. The hand placement surface of claim 11 that conforms to each individual rider's palm regardless of the individual's hand shape, size or position on the hand placement surface due to the elastomeric properties and thickness.

19. The hand placement surface of claim 11 that absorbs road shock and vibration due to the elastomeric properties and thickness.
